(19) United States
(12) Patent Application Publication
(10) Pub. No.: US 2022/0172123 A1
(43) Pub. Date: Jun. 2, 2022

(54) SYSTEMS AND METHODS FOR PERFORMING A SEARCH BASED ON FREEFORM ILLUSTRATION

(71) Applicant: Capital One Services, LLC, McLean, VA (US)

(72) Inventors: Chih-Hsiang CHOW, Plano, TX (US); Steven DANG, Plano, TX (US); Elizabeth FURLAN, Plano, TX (US)

(73) Assignee: Capital One Services, LLC, McLean, VA (US)

(21) Appl. No.: 17/106,838

(22) Filed: Nov. 30, 2020

(51) Int. Cl. G06N 20/20; G06F 16/242; G06F 16/248; G06Q 10/08; G06Q 30/06; G06K 9/62; G06K 9/46

(52) U.S. Cl. CPC G06N 20/20; G06F 16/242; G06F 16/248; G06Q 10/087; G06K 9/6256; G06Q 30/0643; G06K 9/6201; G06K 9/46; G06Q 30/0627

(57) ABSTRACT

An exemplary embodiment of a computer-implemented method of identifying one or more products that correspond to product features of interest to a user may include: receiving an at least partially freeform or sketched illustration of a product from a user device associated with a user; determining at least one feature of the product depicted in the illustration by employing a machine-learning model trained, using (i) at least partially freeform or sketched illustrations from various users depicting products in a same product category as the product and (ii) feature labels assigned to the illustrations, to output one or more features of a depicted product in the product category in an input illustration; generating a search query based on the determined at least one feature; identifying at least one product in an inventory that corresponds to the search query; and providing information associated with the at least one identified product to the user device.

### TECHNICAL FIELD

Various embodiments of the present disclosure relate generally to image-based searching, and, more particularly, to performing a search based on freeform illustration.

### BACKGROUND

Products within a particular product category may vary widely. For example, a vehicle may include a car, a boat, a motorcycle, train, plane, etc. Even further, a car may be a sedan, a sports car, a hatch-back, etc. And still further, a car may be classified by any number of other features, such as make, model, color, size, shape, etc. So too may interest in such features vary widely from customer to customer.

As a result, techniques have been developed in an effort to match a particular product to a particular customer based on product features of interest to the customer. For example, a conventional product search tool may enable filtering of products in a database by selection of one or more features. However, such a tool may be an inexact or inefficient means to identify products or product features of interest to the customer.

Thus, although the customer may have a clear picture of what type and kind of product they want, the conventional product search tool may not provide a ready means for the customer to express that desire. In an example, a customer may desire a particular look and feel for a sports car, but that look and feel may not correspond to the feature options available using the conventional search tool. In other words, the syntax used by the conventional search tool may not align with the way in which the customer thinks about their desired product. This disconnect may interfere with or frustrate the customer's product search, and may negatively impact the customer's experience.

The present disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for image-based product searching.

In one aspect, an exemplary embodiment of a computer-implemented method of identifying one or more products that correspond to product features of interest to a user may include: receiving an at least partially freeform or sketched illustration of a product from a user device associated with a user; determining at least one feature of the product depicted in the illustration by employing a machine-learning model trained, using (i) at least partially freeform or sketched illustrations from various users depicting products in a same product category as the product and (ii) feature labels assigned to the illustrations, to output one or more features of a depicted product in the product category in an input illustration; generating a search query based on the determined at least one feature; identifying at least one product in an inventory that corresponds to the search query; and providing information associated with the at least one identified product to the user device.

In another aspect, an exemplary embodiment of a system for identifying one or more products that correspond to product features of interest to a user may include: a memory storing instructions and a machine-learning model trained, using (i) at least partially freeform or sketched illustrations from various users depicting products in a product category and (ii) feature labels assigned to the illustrations, to output one or more features of a depicted product in the product category in an input illustration; and a processor operatively connected to the memory and configured to execute the instructions to perform acts. The acts may include: receiving an at least partially freeform or sketched illustration of a product from a user device associated with a user; determining at least one feature of the product depicted in the illustration by employing the machine-learning model, wherein the at least one feature corresponds to a freeform or sketched portion of the received illustration; generating a search query based on the determined at least one feature; identifying at least one product in an inventory of products indexed by feature that corresponds to the search query; and providing information associated with the at least one identified product to the user device.

In a further aspect, an exemplary embodiment of a computer-implemented method of training a machine-learning model to output one or more features of a depicted product in a product category in an input illustration may include: training a machine-learning model using (i) at least partially freeform or sketched illustrations from various users depicting products in the product category and (ii) feature labels assigned to the illustrations; receiving an at least partially freeform or sketched illustration of a product from a user device associated with a user; determining at least one feature of the product depicted in the illustration by employing the trained machine-learning model; generating a search query based on the determined at least one feature; identifying at least one product in an inventory that corresponds to the search query; providing information associated with the at least one identified product to the user device; receiving a selection, via the user device, of one or more of the at least one identified product; and updating a training of the machine-learning model based on the selected one or more identified product, the at least one feature, and the received illustration.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary computing environment for performing a search based on an illustration, according to one or more embodiments.

FIG. 2 depicts a flowchart of an exemplary method for performing a search based on an illustration, according to one or more embodiments.

FIGS. 3A and 3B depicts exemplary embodiments of different at least partially freehand or sketched illustrations of different products.

FIG. 4 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

The term “vendor” generally encompasses an entity or person involved in providing, selling, and/or renting products to customers such as a seller, dealer, renter, provider, merchant, or the like, as well as an agent or intermediary of such an entity or person. The term “customer” or the like generally encompass an entity or person that accesses, visits, uses, or receives a benefit or the like from a vendor, and may be a person that is browsing, interested in a product, interested in or engaged in a purchase of a product, or that has purchased a product. A “product” generally encompasses a good, service, or the like having ownership or other rights that may be transferred. A “vehicle” generally encompasses a car, a truck, a motorcycle, a tractor, a bicycle, a boat, an airplane, or any other means of conveyance for a person. A “user,” or the like, generally encompasses a person using and/or interacting with a computing device, and may include a customer, a vendor, an agent or intermediary, or the like.

A customer may desire to purchase a product having a particular look or feel, and/or having particular features. However, there may be a wide variety of available products, and conventional techniques for performing a product search may not align with the way that the customer may articulate or think about their desired product. This misalignment may interfere with or frustrate the customer's product search, and may negatively impact the customer's experience. Accordingly, improvements in technology relating to feature-based searching of products are needed.

In the following description, embodiments will be described with reference to the accompanying drawings. As will be discussed in more detail below, in various embodiments, systems and methods for performing a search based on an illustration are described. In particular, systems and methods are described that pertain to illustrations that are at least partially freeform or sketched. As used herein, a “freehand” portion of an illustration generally encompasses a marking or the like in an illustration that is formed in response to or guided by a motion of a person. For example, a freeform portion of an illustration may be made by applying a pen, pencil, crayon or the like to a piece of paper. In another example, a freeform portion of an illustration may be made by manipulating a computer input device such as a mouse, keyboard, stylus, touch-based interface, or the like so as to form a portion of an electronic image. As used herein, a “sketched” portion of an illustration generally encompasses a marking that acts as an approximation, representation, indication, symbol, rough-in, or the like of the portion of the illustration.

In an exemplary use case, a customer may desire to purchase a product having a particular look or feel, and/or having particular features. The customer may make an illustration of their desired product, e.g., a red sports car with two doors, a sleek rounded frame, and rounded headlights. At least a portion of the illustration is freehand or sketched. In one example, the customer may draw the illustration from scratch. In another example, the customer may add to a partially pre-made illustration or template such as a frame and wheels of a car without a body, headlights, or grill. In another example, the customer may add stamps, stickers, or the like that include pre-made elements or features, such as pre-made wheels that the customer may place at desired locations on the illustration.

In some instances, at least a portion of the illustration may be formed physically, e.g., via markings made on paper or the like. In some instances, a user, e.g., the customer, a vendor, or the like, may use a user device to capture an image of the physical illustration. In some instances, at least a portion the illustration may be formed electronically, e.g., via interaction with an electronic drawing application on the user device, or the like. The user device may transmit the illustration to an image-based search system. The image-based search system may use the illustration to identify a product that matches, at least in part, the look, feel, and/or features desired by the customer, and provide information associated with the matching product to the customer and/or the user device. For example, the image-based search system may determine, e.g., from the customer's illustration, that the customer desires a red sports car with two doors, a sleek rounded frame, and rounded headlights, and may retrieve information on one or more at least partially matching vehicles. Thus, the customer may be able to discover a product matching their desired look, feel, and/or features without having to determine search terms or syntax for the image-based search system.

In some instances, the image-based search system may identify the matching product by determining at least one feature of the product depicted in the illustration. For example, the image-based search system may determine at least one feature of the product depicted in the freeform or sketched portion of the illustration. The image-based search system may generate a search query based on the determined at least one feature, and identify the matching product as matching, at least in part, the generated search query.

In some cases, the image-based search system may identify one or more aspects of a feature based on one or more aspects of the depiction of the feature in the sketched or freehand portion of the illustration. For example, the image-based search system may identify an aspect of a feature such as size, quantity, color, shape, orientation or location relative to the vehicle and/or other features. Aspects of a sketched or freehand feature may also be indicative of importance to the customer. For example, the customer may have roughly sketched a body shape for their desired vehicle, but may have made a relatively more detailed drawing of the desired round headlights, which may be indicative of a relative importance to the customer of such features. A lack of a feature in the illustration may also be indicative of a desire of the customer, e.g., a lack of a convertible roof or the like in the customer's illustration.

In some instances, the image-based search system may employ a first machine-learning model that is trained to output one or more features of a product depicted in an input illustration. In some cases, the image-based search system may be configured to identify features of products in a particular category of products. In some cases, the first machine-learning model may be trained based on (i) at least partially freeform or sketched illustrations from various users depicting products, e.g., products in a same product category, and (ii) feature labels assigned to the illustrations. In some instances, the first machine-learning model may be trained using products in different categories. In some instances, the first machine-learning model includes a combination of machine-learning models, such as a respective model for each different category or sub-category of products.

In some instances, the image-based search system may return a listing of products at least partially matching the generated search query. In some instances, the results may be ranked based on the relative matching with the search query. In some instances, the search query takes into account the importance of different features to the customer. In some instances, the products in the listing are weighted based on the determined importance of the features to the customer.

In some instances, the image-based search system may access, e.g., on or via a vendor system, an inventory of available products that may include information describing features of the products. In some instances, a second machine-learning model is employed to generate the inventory of products that is searchable by the image-based search system. In some instances the second machine-learning model may be trained, based on images of products, e.g., products in a particular category, and labels of features in the products, to output features in an input image, e.g., a photograph, of a product. In some instances, the features of the labels used to train the second machine-learning model are determined by applying the first machine-learning model to the photographs of the products.

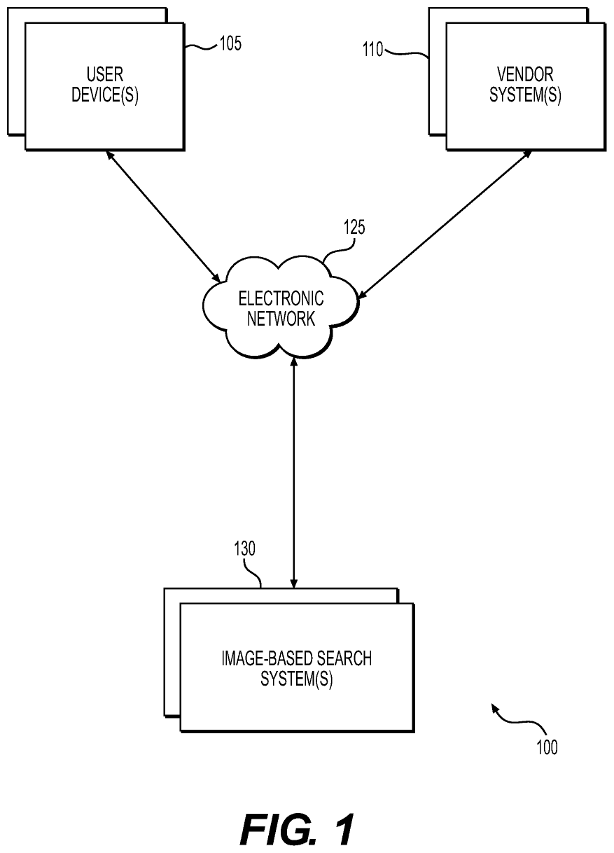

FIG. 1 depicts an exemplary computing environment 100 that may be utilized with techniques presented herein. One or more user device(s) 105 and one or more vendor system(s) 110 may communicate across an electronic network 125. As will be discussed in further detail below, one or more image-based search system(s) 130 may communicate with one or more of the other components of the computing environment 100. The systems and devices of the computing environment 100 may communicate in any arrangement. As will be discussed herein, systems and/or devices of the computing environment 100 may communicate in order to perform and image-based search, e.g., a feature-based image-based search, for a product, and/or other actions.

The user device 105 may be a computer system such as, for example, a desktop computer, a mobile device, etc. In an exemplary embodiment, the user device 105 may be a cellphone, or the like. In some embodiments, the user device 105 may include one or more electronic application(s), e.g., a program, plugin, etc., installed on a memory of the user device 105. In some embodiments, the electronic application(s) may be associated with one or more of the other components in the computing environment 100. For example, the electronic application(s) may include a drawing application, an e-commerce application for purchasing products, a search tool, an image capture application, or the like. The user device 105 may include an input device for making an illustration, e.g., a mouse, keyboard, stylus, touch screen, or the like. The user device 105 may include a camera, scanner, or the like for capturing an image, e.g., of an illustration and/or product.

The vendor system 110 may include an inventory of products. The inventory may include information associated with the products, such as price, availability, location, etc. The inventory may include information associated with features of the products. For example, an inventory of vehicles may include information associated with type (car, truck, boat, etc.), make, model, color, year, number of doors, interior material, body-type, shapes of one or more elements, relative positions and/or orientations of elements, or the like. In some embodiments, the inventory may index products by feature. In other words, information associated with a product may be retrieved in response to a query based on one or more features of that product. Any suitable type of inventory may be used.

In various embodiments, the electronic network 125 may be a wide area network (“WAN”), a local area network (“LAN”), personal area network (“PAN”), or the like. In some embodiments, electronic network 125 includes the Internet, and information and data provided between various systems occurs online. “Online” may mean connecting to or accessing source data or information from a location remote from other devices or networks coupled to the internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). In some embodiments, the electronic network 125 includes or is in communication with a telecommunications network, e.g., a cellular network.

As discussed in further detail below, the image-based search system 130 may be configured to one or more of determine one or more features of a product depicted in an illustration, rank a relative importance of features based on aspects of the depiction of the features in the illustration, generate a search query based on one or more of the determined feature(s), the rank(s) or relative importance of the feature(s), identify a product based on a match, at least in part, between features of the product and one or more of the search query, features identified in the illustration, retrieve and/or output information related to one or more products, or other actions. In some embodiments, the image-based search system 130 may include a memory that stores instructions and/or one or more machine-learning models, and/or other data, as discussed in further detail below.

Although depicted as separate components in FIG. 1, it should be understood that a component or portion of a component may, in some embodiments, be integrated with or incorporated into one or more other components. For example, a portion of the vendor system 110 may be provided to the user device 105 as an electronic portal via the electronic application. At least a portion of image-based search system 130 may be integrated into the vendor system 110, the user device 105, or another system. Any suitable arrangement of the various systems and devices of the computing environment 100 may be used.

In the methods below, various acts are described as performed or executed by a component from FIG. 1, such as image-based search system 130. However, it should be understood that in various embodiments, various components or combinations of components of the computing environment 100 discussed above may execute instructions or perform acts including the acts discussed below. Further, it should be understood that in various embodiments, various steps may be added, omitted, and/or rearranged in any suitable manner.

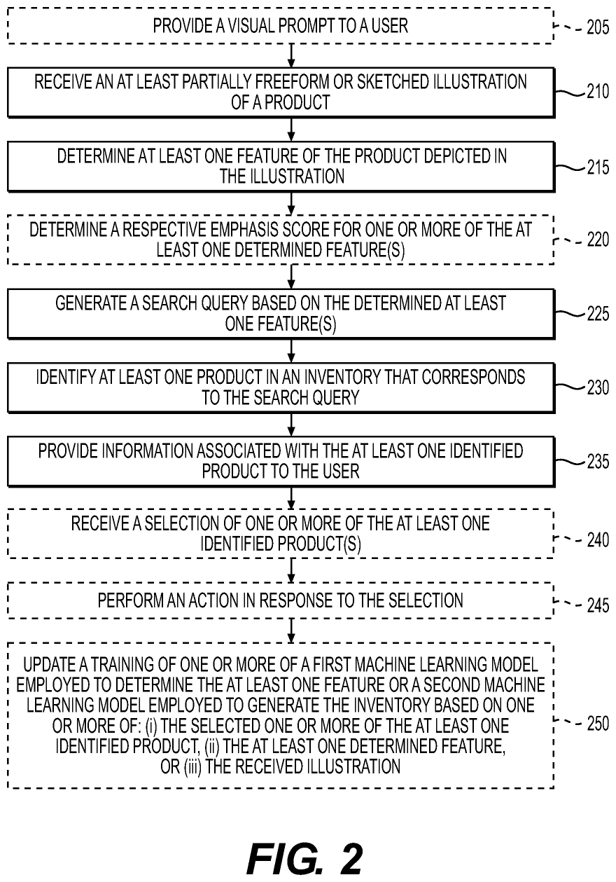

FIG. 2 illustrates an exemplary process for identifying one or more products that correspond to product features of interest to a customer. In some embodiments, a customer may desire information regarding a product in a particular product category having a particular look or feel, and/or particular features. In some embodiments, a customer may desire to purchase a product having a particular look or feel, and/or particular features. The customer may have and/or be associated with a user device 105, e.g., a mobile device, a vendor system 110 with or without a vendor as an intermediary, or the like. In the following method, steps described as associated with a user may be understood to be inclusive of a customer, a vendor, or other person that, for example, may be acting as an intermediary for the customer.

In some embodiments, the user may select a category of products. For example, the user may select vehicles, real estate, jewelry, food, etc. In some embodiments, the user may not selected a category. In some embodiments, a category may be preselected.

In some embodiments, a user may select a sub-category within the category of products. For example, for the category of vehicles, a user may select sports car as a sub-category. Other sub-categories for the category of vehicles may include, for example, sedan, truck, van, sport-utility vehicle, motorcycle, boat, etc. Other categories may include, for example, apparel, appliances, watches, jewelry, electronics, real estate or rental property, food, decor, etc. Any suitable sub-category may be selected from any suitable category. In some embodiments, no sub-category is selected. In some embodiments, a sub-category may be preselected.

Optionally, at step 205, an image-based search system 130 may provide a visual prompt to the user. In some embodiments, the visual prompt may be based on the selected sub-category for the product category. In some embodiments, the image-based search system 130 may provide at least a portion of the visual prompt physically, e.g., via a printout of an image or the like. In some embodiments, the image-based search system 130 may provide at least a portion of the visual prompt electronically, e.g., via a display of the user device 105, the vendor system 110, or another system.

In some embodiments, the visual prompt includes a template associated with the product category and/or the product sub-category. For example, a template for the category of vehicle may include an image of a driver, pilot, or the like, a motor, one or more wheels, one or more seats, and/or any other feature or features that may be commonly associated with the category and/or sub-category. In some embodiments, the visual prompt includes one or more premade features that are configured to be one or more of modified, positioned, or oriented by the user. For example, in physical form, a premade feature may be in the form of a cutout, sticker, stamp, or the like that may be manipulated by the user. In another example, in electronic form, a premade feature may be in the form of an electronic object that may be manipulated by the user. In the category of vehicles, the one or more premade features may include, for example, one or more of a vehicle door, a headlight, a windshield, a grill, a wheel, a portion of a vehicle body, a tail light, or the like.

In some embodiments, the template may be selected from a plurality of templates that correspond to different view angles of the product, e.g., a front, top, side, isometric view, etc. In some embodiments, the one or more premade objects may be selected and/or modified based on the view angle associated with the selected template.

In an exemplary use case, the customer may desire a sports car having a particular look and feel. The image-based search system 130 provides the customer, e.g., via a printer associated with the user device 105 or vendor system 110, a printout of a template associated with sports cars. The template may include a driver, a driver's seat, at least a portion of a chassis of a car, and four wheels. The template may also include one or more stickers, stamps, cutouts, or the like, that represent one or more features available with various sports cars, e.g., various different doors, front hoods, trunks, headlights, exhausts, grills, etc. The customer may manipulate, e.g., position, orient, or the like, the one or more features onto the printout in order to modify the template.

In another exemplary use case, the customer may desire a sports car having a particular look and feel. The image-based search system 130 provides the customer, e.g., via a display associated with the user device 105 or vendor system 110, an electronic depiction of a template associated with sports cars. The template may include a driver, a driver's seat, at least a portion of a chassis of a car, and four wheels. The template may also include one or more electronic objects that represent one or more features available with various sports cars, e.g., various different doors, front hoods, trunks, headlights, exhausts, grills, etc. The customer may manipulate, e.g., position, orient, color, resize, etc., the one or more features onto the electronic depiction in order to modify the template.

The user, e.g., the customer, may generate an at least partially freeform or sketched illustration of the desired product. In some embodiments, the user may make a freehand or sketched marking on the template to form the illustration. In some embodiments, the user may not use a template. In an example, in physical form, the user may use a pen, pencil, crayon, marker, paint, or the like, to make one or more freehand and/or sketched markings on physical media, e.g., a piece of paper, the printout of the template, a whiteboard, a blackboard, or the like. In another example, in electronic form, the user may use a mouse, keyboard, touch screen, stylus, or the like to interact with, for example, an electronic drawing application associated with the user device 105, the vendor system 110, the image-based search system 130, or the like. The freehand and/or sketched portions of the illustration may include and/or be representative of one or more features for the product. The freehand and/or sketched portions of the illustration may include one or more colors, shadings, line weights, levels of detail, etc. In some embodiments, user may include one or more labels for one or more features in the illustration. For example, the user may apply a label to a portion of the illustration. In an exemplary use case, the user may include the text “round headlights” with a line indicating a portion of the illustration as representative of the round headlights. In some embodiments, a label may include a line, circle, or other indicator identifying a region or portion of the illustration.

At step 210, the image-based search system 130 may receive the at least partially freeform or sketched illustration of the product, e.g., from the user device 105, the vendor system 110, or the like. In an example, with the illustrating being in physical form, the user device 105 or the like may capture an image of the illustration via an image capture device such as a camera, scanner, or the like, and may transmit the image of the illustration to the image-based search system 130. In another example, with the illustration being in electronic form, the user device 105 or the like may transmit the illustration in electronic form and/or an electronic image representative thereof, to the image-based search system 130. In a further example in which the image-based search system 130 is at least partially integrated into the user device 105 or the like, the image-based search system 130 may receive the illustration via the electronic drawing application and/or via the mouse, keyboard, touch-screen, stylus, or other input device.

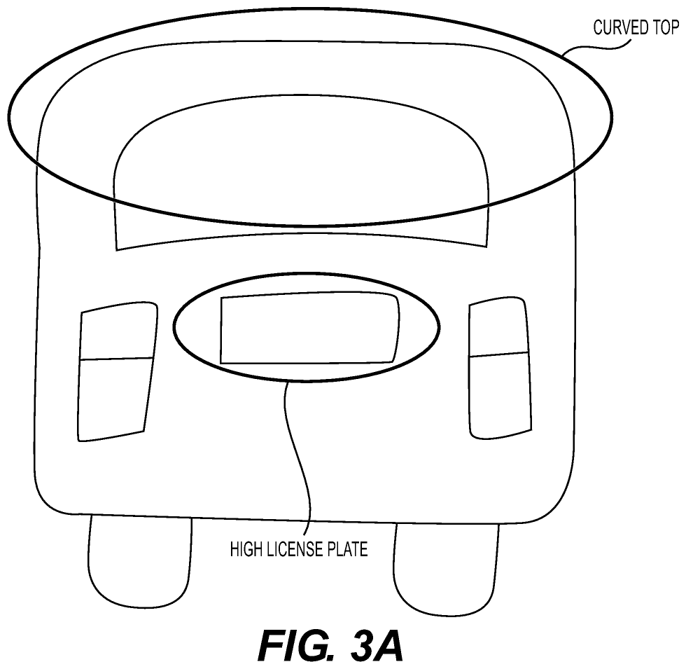

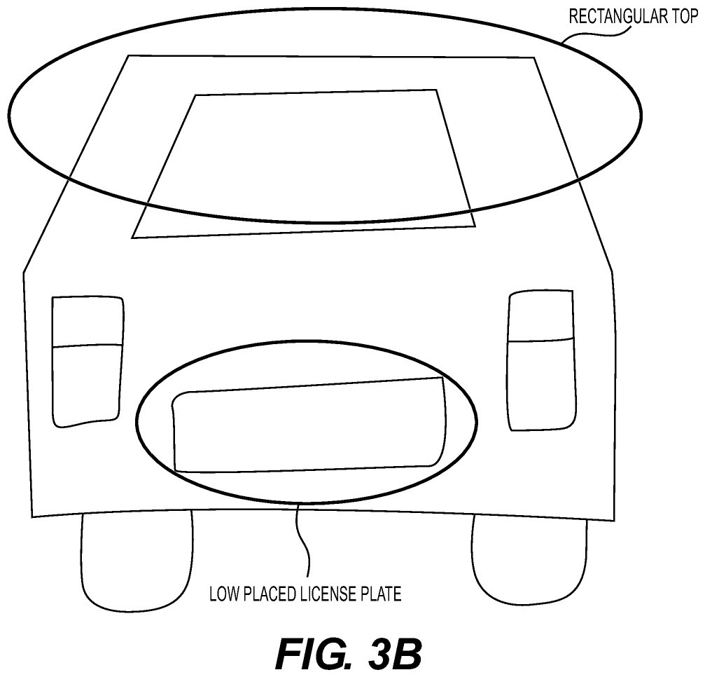

FIGS. 3A and 3B depict exemplary embodiments of illustrations of rear views of different vehicles. FIG. 3A depicts an illustration of a vehicle with a curved top and a high-positioned license plate, and includes labels identifying the aforementioned features. FIG. 3B depicts an illustration of a vehicle with a rectangular top and a low-positioned license plate, and includes labels identifying the aforementioned features.

In some embodiments, the image-based search system 130 may be configured to extract, ignore, modify or replace at least a portion of the illustration. For example, the illustration may include stray marks or other markings that may not be associated with a feature, a label, or the product. For example, the image-based search system 130 may be configured to remove, extract, ignore, or modify lines from textbook or graph paper, or other marks on the illustration.

Returning to FIG. 2, at step 215, the image-based search system 130 may determine at least one feature of the product depicted in the illustration. In some embodiments, the image-based search system 130 may determine a view associated with the depiction of the product in the illustration, and may determine the at least one feature based on the determined view. For example, with regard to FIG. 3A, the image-based search system 130 may determine that the illustration is associated with a rear view. In some embodiments, the image-based search system 130 may determine whether a sub-set of features are present in the illustration based on the associated view. For example, a front grill may not be visible in a rear view of a vehicle, and thus the image-based search system 130 may exclude the front grill from the determination. Similarly, a feature such as rear taillights may be visible in a rear view, and the image-based search system 130 may determine and/or prioritize determination of rear taillights in the image.

In some embodiments, determination of the view and determination of the one or more features may be iterative and/or operative in conjunction with each other. For example, the image-based search system 130 may determine the presence of taillights, and determine the view is more likely to be a rear view based on the presence of taillights. In another example, the image-based search system 130 may determine that the view is a rear view, and determine that a freehand or sketched portion of the illustration is more likely to be taillights based on the determined view.

In some embodiments, the image-based search system 130 may compare one or more portions of the illustration with one or more predetermined features in one or more views. In some embodiments, the determination of the one or more features and/or the view may be based on one or more labels included in the illustration. In some embodiments, determination of a feature may be based on an association between the feature and a feature that is labelled in the illustration. For example, the user may have labeled “round headlights” in the illustration, and the image-based search system 130 may determine that a proximate portion of the illustration is representative of a front grill, or the like, that may be unlabeled in the illustration. In another example, the image-based search system 130 may parse a label, e.g., extract the term “round” from the label “round headlights” to determine an aspect of the feature, e.g., that the headlights are “round.” In another example, the illustration may include a label identifying a region, e.g., a circle or the like, and the image-based search system 130 may extract a portion of the illustration corresponding to the region and/or determine a feature within the portion.

In some embodiments, the image-based search system 130 may employ an image analysis algorithm, a machine-learning model, or the like. As used herein a “machine-learning model” generally encompasses and/or includes data, instructions, algorithms, and/or other information together forming a machine that, once trained, e.g., using a set of training data and a set of ground truths associated with the set of training data, is configured to output a result when provided with a given input.

In some embodiments, the image-based search system 130 may employ a first machine-learning model that may be trained to output one or more features of a product, e.g., a product within a particular category, depicted in an input illustration. In various embodiments, the first machine-learning model may be trained before, during and/or after performance of the method. In some embodiments, the method may include training, tuning, and/or adjusting the first machine-learning model.

In some embodiments, the first machine-learning model may be trained using (i) at least partially freeform or sketched illustrations from various users depicting products, e.g., products in a same product category as the product and (ii) feature labels assigned to the illustrations. Training may be supervised, partially supervised, or unsupervised. In other words, in various embodiments, the machine-learning model may be trained with a training data set as a whole, may be trained stochastically with validation, e.g., by a user, or via any suitable training method.

In some embodiments, the first machine-learning model may be and/or include a convolutional neural network (a “CNN”). A CNN may include one or more layers, e.g., neural nodes, that may include one or more filters that are convolved over an input image in order to identify one or more features present in the input image. One or more layers may also be or include a scaling function, pooling function, or the like. One or more layers may also be or include a fully connected layer associated with one or more classifications of features and/or classification scores as outputs. Any suitable combination of layers may be used. Further, any suitable machine-learning model or architecture may be used.

In some embodiments the first machine-learning model may be trained and/or tuned based on one or more labels included in the illustration. In an exemplary use case, the first machine-learning model may learn an association between a way in which a user may freehand draw or sketch a features, e.g., the feature of “round headlights,” and may apply such learned association to determine one or more other features freehand drawn or sketched in the illustration that may or may not be labeled.

The one or more features that may be determined by the image-based search system 130 may include, for example, a coloration of at least a portion of the depicted product, e.g., a red body, a white interior, etc. The one or more features that may be determined by the image-based search system 130 may include, for example, a presence or lack thereof of at least one predetermined structure associated with the product, e.g., a presence or lack thereof of a hard-top roof, a back seat, a trunk, fog lights, rounded edges, a spoiler, etc. The one or more features that may be determined by the image-based search system 130 may include, for example, a relative position and/or orientation of one or more predetermined structures relative to one or more other predetermined structures and/or relative to the product. In other words, in some embodiments, the image-based search system 130 may determine one or more of a position or orientation of one or more of the at least one determined features relative to the product, e.g., as a whole, and/or to another feature of the product depicted in the illustration. For example, the feature may include a location and/or orientation of a side mirror relative to a car door, a height of the headlights relative to the car as a whole, a slope of a rear portion of the body of the car, etc.

Optionally, at step 220, the image-based search system 130 may determine a respective emphasis score for one or more of the at least one determined feature. In some embodiments, the respective emphasis score may be associated with and/or indicative of an importance of the feature to the user, e.g., relative to another feature or features. Any suitable technique for determining the respective emphasis score may be used. In some embodiments, the emphasis score may be based on one or more aspects of a feature that may be determined by the image-based search system 130.

For example, the respective emphasis score may be based on one or more of a coloration, a size, a line weight, a line style (e.g., ragged, smooth, dashed, curved, straight, broken, continuous, etc.), a shading, a level of detail, or a predetermined shape of a freeform or sketched portion or region of the illustration corresponding to the at least one feature. In some embodiments, the aspect may be evaluated relative to at least one other feature of the depicted product in the received illustration. For example, a line weight used by the user to depict the round headlights may be thinner or thicker than a line weight used to depict the windshield. Such a relative difference may be indicative that the user placed more emphasis on one feature relative to another, which may be indicative of a relative level of importance of the features to the user.

In another example, the respective emphasis score may be based on an extent of time taken to generate one or more portions of the illustration. In some embodiments, the image-based search system 130 may include a timer or the like configured to capture the extent of time taken to generate one or more portions of the illustration. In some embodiments, the image-based search system 130 may determine the extent of time based on, for example, a video of the generation of the illustration, periodic images of the illustration during the generation, user submissions of time data, etc. In some embodiments, the respective emphasis score for a particular feature may be based on an extent of time taken to generate that feature. In some embodiments, the respective emphasis score for a particular feature may be based on an extent of time taken to generate that feature relative to an extent of time taken to generate another feature and/or the illustration as a whole. In some embodiments, the image-based search system 130 may include time data that includes one or more baseline periods of time for generating one or more features and/or the illustration as a whole. In some embodiments, the respective emphasis score for a particular feature may be based on an extent of time taken to generate that feature relative to a baseline time for generating that feature.

In some embodiments, the one or more baseline times may be based on historical times of one or more users for generating one or more features and/or one or more illustrations. In some embodiments, one or more of the extent of time for generating one or more features and/or the illustration as a whole may be normalized against one or more of the baseline times. For example, the image-based search system 130 may determine a ratio of an extent of time to generate the illustration overall with a baseline time to generate an illustration overall, normalize one or more extents of time to generate one or more features based on the determined ratio, and base the respective emphasis score on a comparison of the normalized time to generate the one or more features with baseline times to generate the one or more features.

In some embodiments, the image-based search system 130 may determine the respective emphasis score for a particular feature based on an extent of time taken to generate that feature by employing another machine-learning model. The other machine-learning model may be trained to output whether one or more extents of time taken to generate one or more features and/or the illustration as a whole are anomalous (e.g., shorter or longer than predicted), and base the respective emphasis score on the output. For example, the other machine-learning model may determine that a time taken to generate a door was longer than expected, and assign a relatively higher emphasis score to the door, and may determine that a time taken to generate a front grill was shorter than expected, and assign a relatively lower emphasis score. In some embodiments, the other machine-learning model may be trained based on input that includes (i) illustrations and time data corresponding to the generation of the illustrations as training data, and (ii) user assigned emphasis scores for one or more features of the illustrations as ground truth.

In some embodiments, the respective emphasis score may be based on a plurality of factors, such as combinations of the factors discussed above and/or others. In some embodiments, an impact of different factors may be assigned one or more weights relative to each other. For example, the respective emphasis score for a particular feature may be based on the extent of time taken to generate the feature and a line weight of the feature. The image-based search system 130 may assign a first score based on the extent of time factor, e.g., in the manner discussed above, and may assign a second score based on the line weight factor, e.g., in the manner discussed above. The image-based search system 130 may assign a first weight to the first score, and a second weight to the second score, and may determine an overall score based on the weighted first and second scores, e.g., via a weighted average or any suitable type of weighted scoring.

In some embodiments, the one or more weights may be predetermined. In some embodiments, the one or more weights may be determined based on the generation of the illustration. For example, in some embodiments, the image-based search system 130 may determine that there is a relatively low variance in line weight throughout the illustration and/or a portion thereof, and may assign a relatively lower weight to the line weight factor. In another example, the image-based search system 130 may determine that there is a relatively high variance in the line weight throughout the illustration and/or a portion thereof, and may assign a relatively higher weight to the line weight factor. In some embodiments, the one or more weights may be determined based on a comparison of one or more aspects of the illustration with one or more aspects of one or more historical illustrations. For example, the one or more historical illustrations may have an average line weight and/or range of variance of line weight, and the weight for the line weight factor may be based on a comparison of the average line weight of the illustration and/or the range of variance of the line weight in the illustration with the average line weight or line weight variance of the one or more historical illustrations.

In some embodiments, the aspect may be evaluated relative to a baseline and/or normalized emphasis score for the product, e.g., as a whole. For example, the freehand or sketched portions of the drawing may have an overall average line weight, and one or more parts of the freehand or sketched portions may have a line weight that differs from the average line weight by at least a predetermined threshold, whereby such difference may be indicative of a different amount of emphasis by the user. In some embodiments, the image-based search system 130 may determine local baseline or normalized emphasis scores for one or more regions of the illustration, and compare emphasis scores for parts or features in the illustration relative to a corresponding local baseline or normalized emphasis score.

In an exemplary use case, the user may quickly sketch a general body shape for a car, which may result in a jagged and/or broken line freehand or sketched feature. The user may also draw a license plate with a greater amount of care and detail, which may result in cleaner, darker lines. Such aspects may be indicative of different amounts of emphasis, and thus different importance of the features to the user.

At step 225, the image-based search system 130 may generate a search query based on the determined at least one feature. The search query may include and/or be based on information associated with one or more aspects of the determined at least one feature, e.g., orientation, position, size, etc. The search query may include and/or be based on the respective emphasis score determined for one or more of the at least one features. Any suitable type of search query may be used. For example, Boolean logic may be used to associate features and/or aspects of the features. In another example, the respective emphasis score may be used to determine a weight or weights for one or more features included in the search query.

At step 230, the image-based search system 130 may identify at least one product in an inventory, e.g., the inventory of the vendor system 110 or the like, that corresponds to the search query. In some embodiments, the inventory may include information associated with a plurality of products and respective one or more features associated with each product. In some embodiments, the respective one or more features associated with each product may be determined via an image analysis algorithm, a machine-learning model, or the like. For example, in some embodiments, the respective one or more features associated with each product may be determined, e.g., via the image-based search system 130 and/or another system, via a second machine-learning model. The second machine-learning model may be trained to identify and/or output features of a product depicted in an input image, e.g., a photograph of the product. In some embodiments, the second machine-learning model may be trained using a second set of training data including images of products, e.g., in a particular product category or sub-category, and labels of features of the products as ground truth.

In some embodiments, the information associated with the products in the inventory and/or the labels of features in the second set of training data are based on the labels of features from the first set of training data. In other words, the labels in the training data for the first machine-learning model may be indicative of features that are more likely to be represented in a freehand and/or sketched illustration of a product, and thus such labels may form and/or be added to a pool of labels to be used to identify products in the inventory and/or train the second machine-learning model.

The identifying of the at least one product in the inventory may include any suitable search technique. In some embodiments, the image-based search system 130 may employ a clustering algorithm, a scoring algorithm, a search algorithm, or the like, or combinations thereof.

For example, in some embodiments, the search query may be used to define a point in a dimensional space in which each axis corresponds to one or more features and a location on such axis corresponds to different possible values for that feature. Different products in the inventory may thus be placed at a location in the dimensional space corresponding to the features of that product. Weights, e.g., emphasis scores, may be applied as a scaling factor to the axis of the corresponding feature. A distance between a product and the point defined by the search query may be indicative of a correspondence between the product and the search query. In other words, a closest product and/or a cluster of products close to the search query may be identified as product(s) corresponding to the search query. Any suitable clustering technique or the like may be used.

In another example, a product may be scored based on a comparison between the features in the search query and the features of the product. For example, each matching feature may be given a base score of 1, and each non-matching feature may be given a base score of −1. A weight associated with the emphasis score corresponding to that feature may be applied to the base score. A total score for the product may be based on the combination of the scores for each of the features. Any suitable scoring technique may be used.

At step 235, the image-based search system 130 may provide information associated with the at least one identified product to the user, e.g., to the customer via the user device 105. The information may include, for example, a product name, a price, information regarding one or more features of the product, an availability of the product, a location of the product, or the like. In some embodiments, the information is configured to cause the user device 105 or another system to provide a selectable option to one or more of initiate a purchase for the identified product, contact the vendor regarding the identified product, request further information regarding the identified product, or the like.

In some embodiments, the image-based search system 130 may provide information associated with a plurality of identified products to the customer, e.g., via the user device 105. In some embodiments, the plurality of identified products may be ranked and/or ordered based on, for example, an amount of correspondence between features of the identified products and the search query, the emphasis score(s) for the determined features, and/or any other suitable criteria such as price, availability location, e.g., distance from a location of the customer or the user device 105, etc. In some embodiments, the information associated with the plurality of identified products may be displayed as a list of selectable objects corresponding to the identified products, e.g., as a listing of search results on an electronic application on the user device 105, or the like.

Optionally, at step 240, the image-based search system 130 may receive a selection e.g., via the user device 105, of one or more of the at least one identified products.

Optionally, at step 245, the image-based search system 130 may perform an action in response to the selection. The action may include one or more of initiating a purchase for the identified product, facilitating or initiating communication between the customer and/or user and the vendor regarding the identified product, requesting further information regarding the identified product, or the like.

Optionally, at step 250, the image-based search system 130 may update the training of the first machine-learning model and/or the second machine-learning model based on one or more of: (i) the selected one or more of the at least one identified product, (ii) the at least one determined feature, or (iii) the received illustration. For example, in some embodiments, one or more of the selected products having a feature corresponding to a feature determined to be depicted in the received illustration may be indicative that the feature was correctly determined.

In another example, the first machine-learning model may have only partially determined a feature or may not have determined a feature depicted in the illustration. In an exemplary use case, it may be unclear whether a freehand drawing or sketch of a roof of a car depicted in an illustration is rounded or rectangular. The user selecting a plurality of vehicles that have a rounded roof, e.g., all selected vehicles have a rounded roof or more of the selected vehicles have a rounded roof than not, may be indicative that the freehand drawing or sketch of the roof of the car depicted in the illustration is rounded. The image-based search system 130 may update the training of the first machine-learning model based on such indication.

In another exemplary embodiment, the image-based search system 130 may identify one or more features that were determined in the illustration, but that may not be included in the information regarding features of products in the inventory. For example, the user may have sketched or drawn a hood ornament that was determined by the machine-learning model, but the inventory may not include a record of which products include hood ornaments in general, or a specific type of hood ornament in particular. In some embodiments, the image-based search system 130 may employ the second machine-learning model to identify products that have the unaccounted for feature. For example, the second machine-learning model may be employed to identify products in the inventory that have a hood ornament, etc. In some embodiments, the image-based search system 130 may generate a request, e.g., to the vendor system 110 or a user associated with the inventory and/or the image-based search system 130 or the like, to update the information in the inventory.

In general, any process or operation discussed in this disclosure that is understood to be computer-implementable, such as the process illustrated in FIG. 2, may be performed by one or more processors of a computer system, such any of the systems or devices in the computing environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

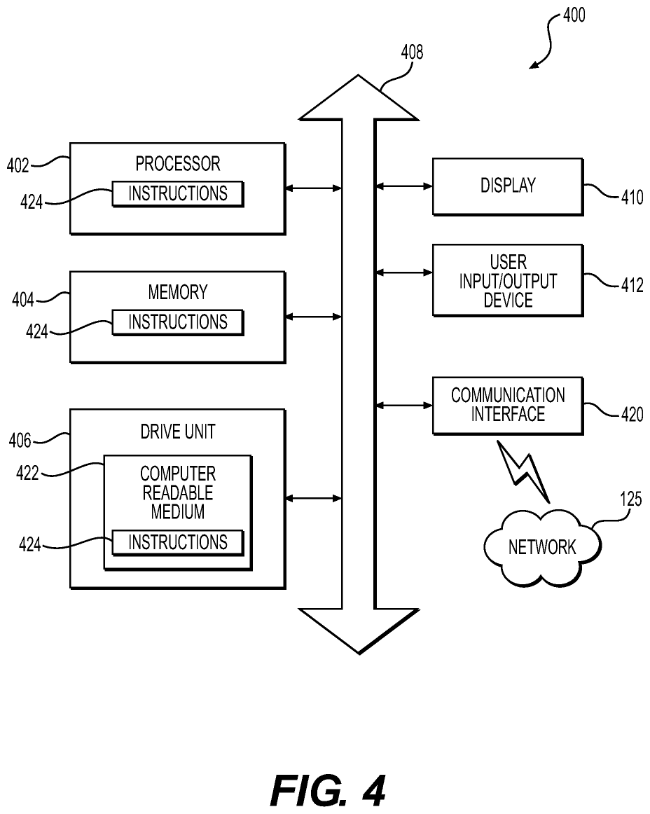

FIG. 4 is a simplified functional block diagram of a computer 400 that may be configured as a device for executing the methods of FIG. 2, according to exemplary embodiments of the present disclosure. FIG. 4 is a simplified functional block diagram of a computer that may be configured as the image-based search system 130 and/or another system according to exemplary embodiments of the present disclosure. In various embodiments, any of the systems herein may be an assembly of hardware including, for example, a data communication interface 420 for packet data communication. The computer 400 also may include a central processing unit (“CPU”) 502, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 and/or computer readable medium 422). The computer 400 also may include input and output ports 412 and/or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer, an automobile entertainment system, a home entertainment system, etc. Also, the presently disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method of identifying one or more products that correspond to product features of interest to a user, the method comprising:
receiving an at least partially freeform or sketched illustration of a product from a user device associated with a user;
determining at least one feature of the product depicted in the received illustration by employing a machine-learning model trained, using (i) at least partially freeform or sketched illustrations from various users depicting products in a same product category as the product and (ii) feature labels assigned to the illustrations, to output one or more features of a depicted product in the product category in an input illustration;
generating a search query based on the determined at least one feature;
identifying at least one product in an inventory that corresponds to the search query; and
providing information associated with the at least one identified product to the user device.

2. The computer-implemented method of claim 1, wherein the one or more features determinable via the machine-learning model includes a coloration of at least a portion of the depicted product.

3. The computer-implemented method of claim 1, wherein the one or more features determinable via the machine-learning model includes a presence of at least one predetermined structure associated with the product.

4. The computer-implemented method of claim 3, wherein the one or more features determinable via the machine-learning model further includes one or more of a relative position or relative orientation of the at least one predetermined structure relative to one or more of the product or a further predetermined structure associated with the product.

5. The computer-implemented method of claim 1, further comprising:
determining a respective emphasis score for the at least one feature, wherein generating the search query is further based on the respective emphasis score.

6. The computer-implemented method of claim 5, wherein the respective emphasis score is based on one or more of a coloration, a size, a line weight, a line style, a shading, a level of detail, or a predetermined shape of a freeform or sketched portion of the received illustration corresponding to the at least one feature, relative to at least one other feature of the depicted product in the received illustration.

7. The computer-implemented method of claim 6, wherein the respective emphasis score is normalized relative to an emphasis score for the depicted product.

8. The computer-implemented method of claim 1, wherein the one or more features determinable via the machine-learning model includes a lack of a presence of at least one predetermined structure associated with the product.

9. The computer-implemented method of claim 1, further comprising:
receiving a selection, via the user device, of one or more of the at least one identified product; and
updating a training of the machine-learning model based on the selected one or more identified product, the at least one feature, and the received illustration.

10. The computer-implemented method of claim 1, further comprising:
providing a visual prompt to the user.

11. The computer-implemented method of claim 10, wherein the visual prompt includes a template associated with the product category.

12. The computer-implemented method of claim 10, wherein the visual prompt includes one or more premade features that are configured to be one or more of modified, positioned, or oriented by the user.

13. The computer-implemented method of claim 1, further comprising:
determining one or more of a position or an orientation of the at least one feature relative to one or more of the depicted product or another feature of the product depicted in the illustration;
wherein generating the search query is further based on the one or more determined relative position or orientation.

14. The computer-implemented method of claim 1, wherein:
the inventory includes information associated with a plurality of products and respective one or more features associated with each product; and
the respective one or more features associated with each product is determined via a second machine-learning model trained, based on images of products in the product category and labels of features in the products, to identify features in a given image of a product.

15. A system for identifying one or more products that correspond to product features of interest to a user, the system comprising:
a memory storing instructions and a machine-learning model trained, using (i) at least partially freeform or sketched illustrations from various users depicting products in a product category and (ii) feature labels assigned to the illustrations, to output one or more features of a depicted product in the product category in an input illustration; and
a processor operatively connected to the memory and configured to execute the instructions to perform acts including:
receiving an at least partially freeform or sketched illustration of a product from a user device associated with a user;
determining at least one feature of the product depicted in the received illustration by employing the machine-learning model, wherein the at least one feature corresponds to a freeform or sketched portion of the received illustration;
generating a search query based on the determined at least one feature;
identifying at least one product, in an inventory of products indexed by feature, that corresponds to the search query; and
providing information associated with the at least one identified product to the user device.

16. The system of claim 15, wherein the at least one feature of the product depicted in the illustration includes one or more of:
a coloration of at least a portion of the depicted product; or
a presence of at least one predetermined structure associated with the product.

17. The system of claim 16, wherein the at least one feature of the product depicted in the illustration further includes one or more of a relative position or relative orientation of the at least one predetermined structure relative to one or more of the product or a further predetermined structure associated with the product.

18. The system of claim 15, wherein the acts further include:
determining a respective emphasis score for the at least one feature;
generating the search query is further based on the respective emphasis score; and
the respective emphasis score is based on one or more of a coloration, a size, a line weight, a line style, a shading, a level of detail, or a predetermined shape of a freeform or sketched portion of the received illustration corresponding to the at least one feature, relative to at least one other feature of the depicted product in the received illustration.

19. The system of claim 15, wherein the at least one feature of the product depicted in the illustration includes a lack of a presence of at least one predetermined structure associated with the product.

20. A computer-implemented method of training a machine-learning model to output one or more features of a depicted product in a product category in an input illustration, the method comprising:
training a machine-learning model using (i) at least partially freeform or sketched illustrations from various users depicting products in the product category and (ii) feature labels assigned to the illustrations;
receiving an at least partially freeform or sketched illustration of a product from a user device associated with a user;
determining at least one feature of the product depicted in the received illustration by employing the trained machine-learning model;
generating a search query based on the determined at least one feature;
identifying at least one product in an inventory that corresponds to the search query;
providing information associated with the at least one identified product to the user device;
receiving a selection, via the user device, of one or more of the at least one identified product; and
updating a training of the machine-learning model based on the selected one or more identified product, the at least one feature, and the received illustration.
